(19) United States
(12) Patent Application Publication
(10) Pub. No.: US 2017/0017063 A1
(43) Pub. Date: Jan. 19, 2017

(54) Lens assembly

(71) Applicants: Li-yang Song, Shenzhen City (CN); Hui-qing Chen, Shenzhen City (CN); Jian-mei Chen, Shenzhen City (CN); Jian Wei, Shenzhen City (CN)

(72) Inventors: Li-yang Song, Shenzhen City (CN); Hui-qing Chen, Shenzhen City (CN); Jian-mei Chen, Shenzhen City (CN); Jian Wei, Shenzhen City (CN)

(73) Assignees: Sintai Optical (Shenzhen) Co., Ltd., Shenzhen City (CN); Asia Optical International Ltd., Taichung (TW)

(21) Appl. No.: 14/999,803

(22) Filed: Jun. 29, 2016

(30) Foreign Application Priority Data
Jul. 17, 2015 (CN) 201510423565.5

(51) Int. Cl. G02B 13/00; G02B 9/16

(52) U.S. Cl. CPC G02B 13/0035; G02B 9/16; G02B 5/20

(57) ABSTRACT

A lens assembly includes a stop, a first lens, a second lens and a third lens, all of which are arranged in sequence from an object side to an image side along an optical axis. The first lens is a plano-convex lens with positive refractive power and includes a convex surface facing the object side. The second lens is with negative refractive power. The third lens is with positive refractive power and includes a convex surface facing the object side. The third lens satisfies 0<f₃/f<1, wherein f₃ is an effective focal length of the third lens and f is an effective focal length of the lens assembly.

### BACKGROUND OF THE INVENTION

Field of the Invention

The invention relates to a lens assembly.

Description of the Related Art

Range finders have been continually developed toward miniaturization. Therefore, lens assemblies used for range finders also need to be developed toward miniaturization. However, the well-known lens assemblies used for range finders are with large volume and can't satisfy requirements of present. Therefore, a lens assembly needs a new structure in order to meet the requirements of miniaturization and high resolution.

### BRIEF SUMMARY OF THE INVENTION

The invention provides a lens assembly to solve the above problems. The lens assembly of the invention is provided with a shortened total lens length and a high resolution and still has a good optical performance.

The lens assembly in accordance with an exemplary embodiment of the invention includes a stop, a first lens, a second lens and a third lens, all of which are arranged in sequence from an object side to an image side along an optical axis. The first lens is a plano-convex lens with positive refractive power and includes a convex surface facing the object side. The second lens is with negative refractive power. The third lens is with positive refractive power and includes a convex surface facing the object side. The third lens satisfies 0<f₃/f<1, wherein f₃ is an effective focal length of the third lens and f is an effective focal length of the lens assembly.

In another exemplary embodiment, the first lens satisfies 0<f₁/f<1, wherein f₁ is an effective focal length of the first lens and f is an effective focal length of the lens assembly.

In yet another exemplary embodiment, the second lens satisfies f₂/f<0, wherein f₂ is an effective focal length of the second lens and f is an effective focal length of the lens assembly.

In another exemplary embodiment, the lens assembly satisfies 0<BFL/TTL<1, wherein BFL is an interval from an image side surface of the third lens to an image plane along the optical axis and TTL is an interval from the convex surface of the first lens to the image plane along the optical axis.

In yet another exemplary embodiment, the first lens and the second lens are spherical lenses.

In another exemplary embodiment, the third lens is an aspheric lens.

In yet another exemplary embodiment, the first lens, the second lens and the third lens are made of plastic material.

In another exemplary embodiment, the lens assembly further includes an optical filter disposed between the third lens and the image side.

In yet another exemplary embodiment, the second lens is a biconcave lens and the third lens is a biconvex lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens assembly in accordance with a first embodiment of the invention;

FIG. 2A depicts a longitudinal aberration diagram of the lens assembly in accordance with the first embodiment of the invention;

FIG. 2B is a field curvature diagram of the lens assembly in accordance with the first embodiment of the invention;

FIG. 2C is a distortion diagram of the lens assembly in accordance with the first embodiment of the invention;

FIGS. 2D-2F are transverse ray fan diagrams of the lens assembly in accordance with the first embodiment of the invention;

FIG. 2G is a lateral color diagram of the lens assembly in accordance with the first embodiment of the invention;

FIG. 2H is a modulation transfer function diagram of the lens assembly in accordance with the first embodiment of the invention;

FIGS. 2I-2K are spot diagrams of the lens assembly in accordance with the first embodiment of the invention;

FIG. 3 is a lens layout and optical path diagram of a lens assembly in accordance with a second embodiment of the invention;

FIG. 4A depicts a longitudinal aberration diagram of the lens assembly in accordance with the second embodiment of the invention;

FIG. 4B is a field curvature diagram of the lens assembly in accordance with the second embodiment of the invention;

FIG. 4C is a distortion diagram of the lens assembly in accordance with the second embodiment of the invention;

FIGS. 4D-4F are transverse ray fan diagrams of the lens assembly in accordance with the second embodiment of the invention;

FIG. 4G is a lateral color diagram of the lens assembly in accordance with the second embodiment of the invention;

FIG. 4H is a modulation transfer function diagram of the lens assembly in accordance with the second embodiment of the invention; and

FIGS. 4I-4K are spot diagrams of the lens assembly in accordance with the second embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

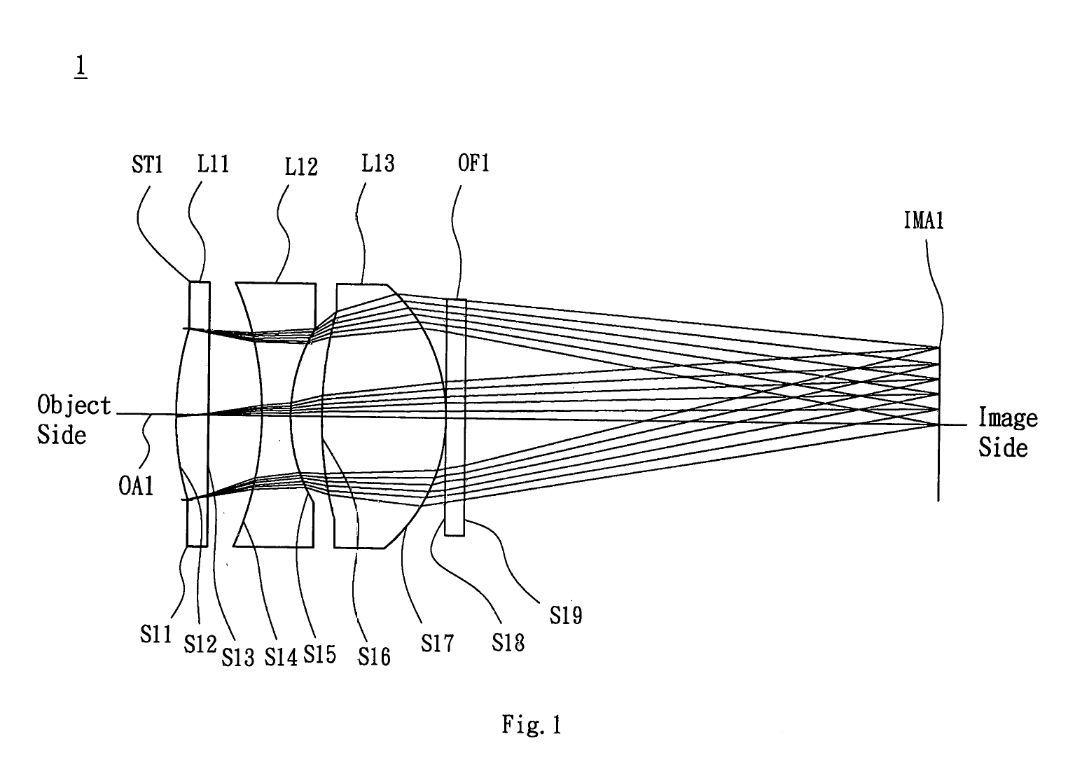

Referring to FIG. 1, FIG. 1 is a lens layout and optical path diagram of a lens assembly in accordance with a first embodiment of the invention. The lens assembly 1 includes a stop ST1, a first lens L11, a second lens L12, a third lens L13 and an optical filter OF1, all of which are arranged in sequence from an object side to an image side along an optical axis OA1. In operation, an image of light rays from the object side is formed at an image plane IMA1. The first lens L11 is a plano-convex lens with positive refractive power and made of plastic material, wherein the object side surface S12 is a convex surface, the image side surface S13 is a plane surface and the object side surface S12 is a spherical surface. The second lens L12 is a biconcave lens with negative refractive power and made of plastic material, wherein both of the object side surface S14 and image side surface S15 are spherical surfaces. The third lens L13 is a biconvex lens with positive refractive power and made of plastic material, wherein both of the object side surface S16 and image side surface S17 are aspheric surfaces. Both of the object side surface S18 and image side surface S19 of the optical filter OF1 are plane surfaces.

In order to maintain excellent optical performance of the lens assembly in accordance with the first embodiment of the invention, the lens assembly 1 must satisfy the following four conditions:

0<f1₁/f1<1 (1)

f1₂/f1<0 (2)

0<f1₃/f1<1 (3)

0<BFL1/TTL1<1 (4)

wherein f1 is an effective focal length of the lens assembly 1, f1₁ is an effective focal length of the first lens L11, f1₂ is an effective focal length of the second lens L12, f1₃ is an effective focal length of the third lens L13, BFL1 is an interval from the image side surface S17 of the third lens L13 to the image plane IMA1 along the optical axis OA1, and TTL1 is an interval from the object side surface S12 of the first lens L11 to the image plane IMA1 along the optical axis OA1. When the condition (1) is satisfied, the positive refractive power of the first lens L11 can be adjusted appropriately so as to help shortening the total lens length of the lens assembly 1. When the condition (2) is satisfied, the negative refractive power of the second lens L12 can be adjusted appropriately so as to compensate aberration that is generated by the positive first lens L11. When the condition (3) is satisfied, the positive refractive power of the third lens L13 can be adjusted appropriately so that the lens assembly 1 has shorter total lens length, the refraction change of light is gentler after pass through the lens, and can effectively reduce the generation of aberration and the loss of peripheral brightness. When the condition (4) is satisfied, it ensures that the optical system has enough back focal length to assemble and focus the lens assembly 1.

By the above design of the lenses and stop ST1, the lens assembly 1 is provided with a shortened total lens length, an effective corrected aberration and an increased resolution.

In order to achieve the above purposes and effectively enhance the optical performance, the lens assembly 1 in accordance with the first embodiment of the invention is provided with the optical specifications shown in Table 1, which include the effective focal length, F-number, total lens length, radius of curvature of each lens surface in mm, thickness between adjacent surface in mm, refractive index of each lens and Abbe number of each lens, and surface number S11-S19 represent surfaces in sequence from the object side to the image side. Table 1 shows that the effective focal length is equal to 9.984 mm, F-number is equal to 3.0 and total lens length is equal to 15.4647 mm for the lens assembly 1 of the first embodiment of the invention.

TABLE 1
Effective Focal Length = 9.984 mm F-number = 3.0
Total Lens Length = 15.4647 mm

| | Radius | | | | |
|---|---|---|---|---|---|
| | of | | | | |
| Surface | Curvature | Thickness | | | |
| Number | (mm) | (mm) | Nd | Vd | Remark |
| S11 | ∞ | −0.2484 | | | Stop ST1 |
| S12 | 5.6975 | 0.6601 | 1.585 | 29.90 | The First Lens L11 |
| S13 | ∞ | 1.0747 | | | |
| S14 | −6.5131 | 0.5929 | 1.585 | 29.90 | The Second Lens L12 |
| S15 | 3.3170 | 0.6354 | | | |
| S16 | 6.5497 | 2.5094 | 1.525 | 56.35 | The Third Lens L13 |
| S17 | −3.5244 | 0 | | | |
| S18 | ∞ | 0.4 | 1.516 | 64.1 | Optical Filter OF1 |
| S19 | ∞ | 9.5921 | | | |

The aspheric surface sag z of each lens in table 1 can be calculated by the following formula:

z=ch²/{1+[1−(k+1)c²h²]^{1/2}}+Ah⁴+Bh⁶+Ch⁸+Dh¹⁰+Eh¹²+Fh¹⁴

where c is curvature, h is the vertical distance from the lens surface to the optical axis, k is conic constant and A, B, C, D, E and F are aspheric coefficients.

In the first embodiment, the conic constant k and the aspheric coefficients A, B, C, D, E, F of each surface are shown in Table 2.

TABLE 2

| Surface | | | | | | | |
|---|---|---|---|---|---|---|---|
| Number | k | A | B | C | D | E | F |
| S16 | −2.7438 | −3.56E−04 | −1.39E−03 | 1.38E−03 | −7.45E−04 | 1.66E−04 | −1.26E−5 |
| S17 | −0.1818 | −1.48E−03 | 5.98E−04 | −2.97E−04 | 4.49E−05 | −5.51E−6 | 4.09E−7 |

For the lens assembly 1 of the first embodiment, the effective focal length f1 of the lens assembly 1 is equal to 9.984 mm, the effective focal length f1₁ of the first lens L11 is equal to 9.7315 mm, the effective focal length f1₂ of the second lens L12 is equal to −3.6720 mm, the effective focal length f1₃ of the third lens L13 is equal to 4.7707 mm, the interval BFL1 from the image side surface S17 of the third lens L13 to the image plane IMA1 along the optical axis OA1 is equal to 9.9921 mm and the interval TTL1 from the object side surface S12 of the first lens L11 to the image plane IMA1 along the optical axis OA1 is equal to 15.4647 mm. According to the above data, the following values can be obtained:

f1₁/f1=0.975,

f1₂/f1=−0.368,

f1₃/f1=0.478,

BFL1/TTL1=0.646

which respectively satisfy the above conditions (1)-(4).

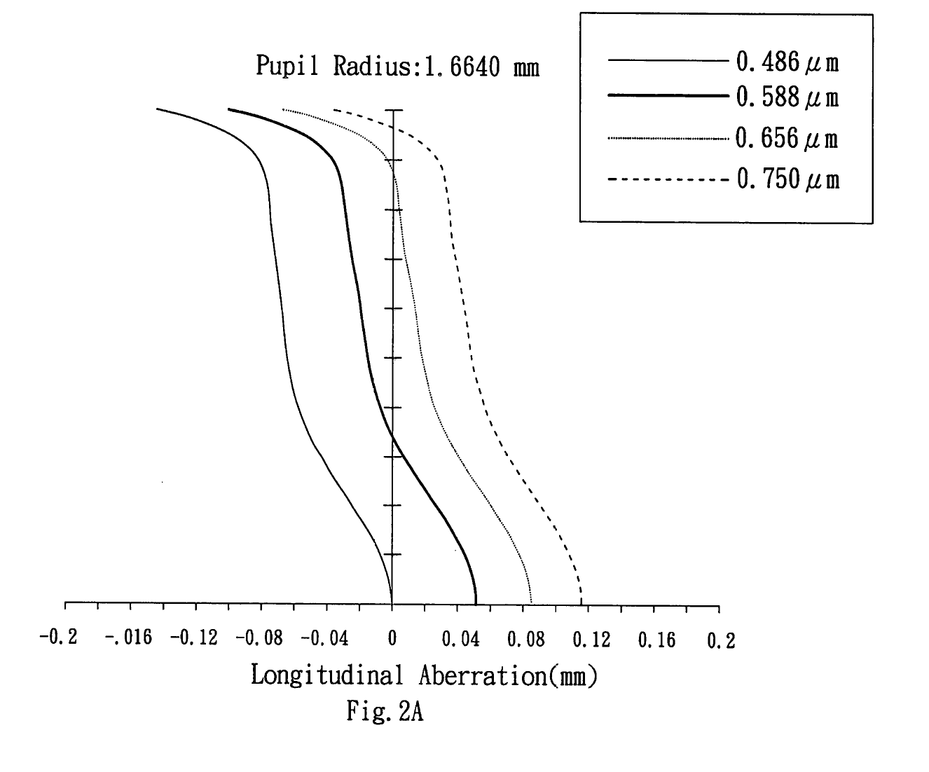

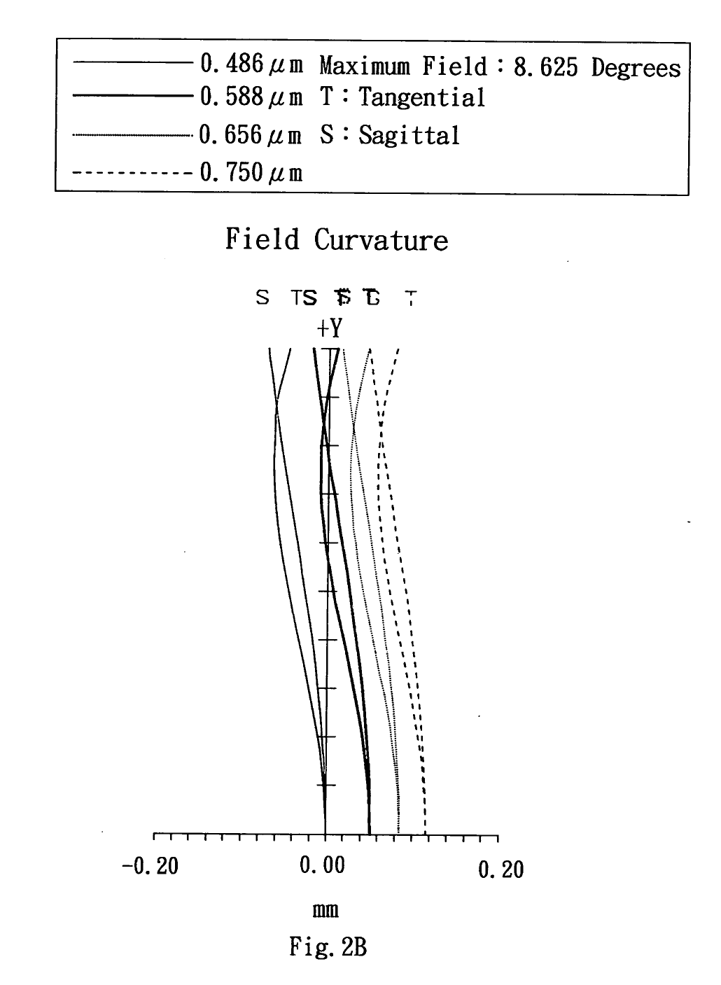

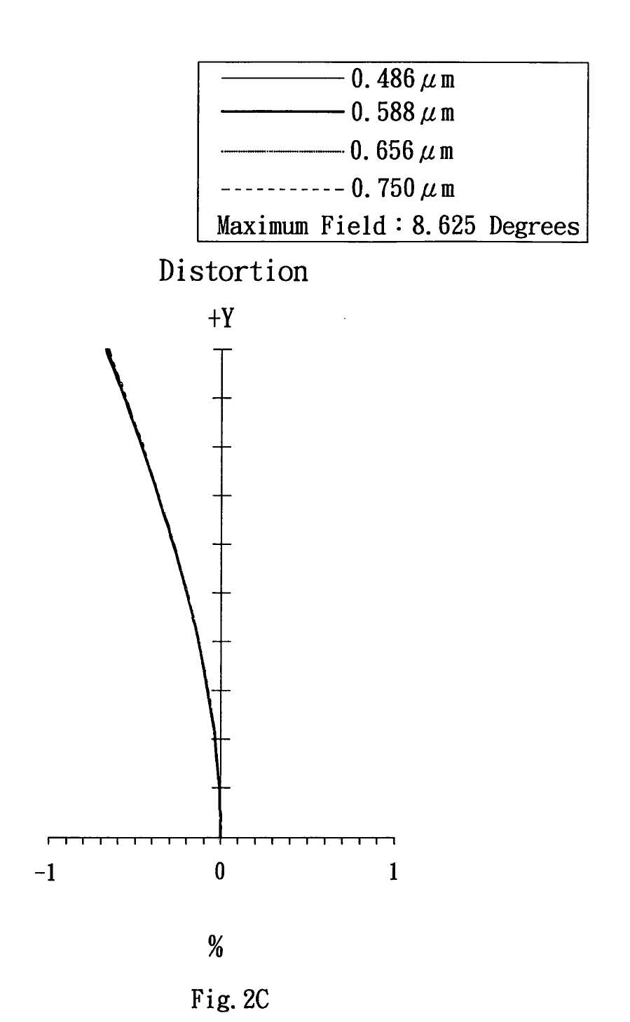

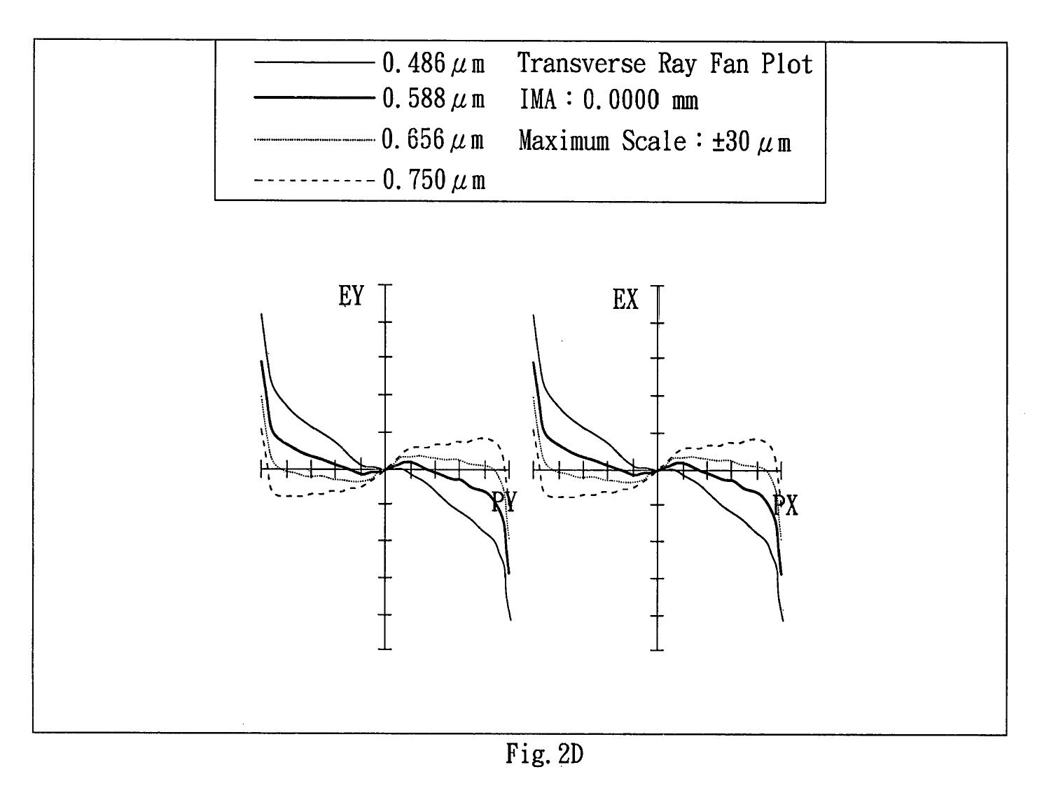

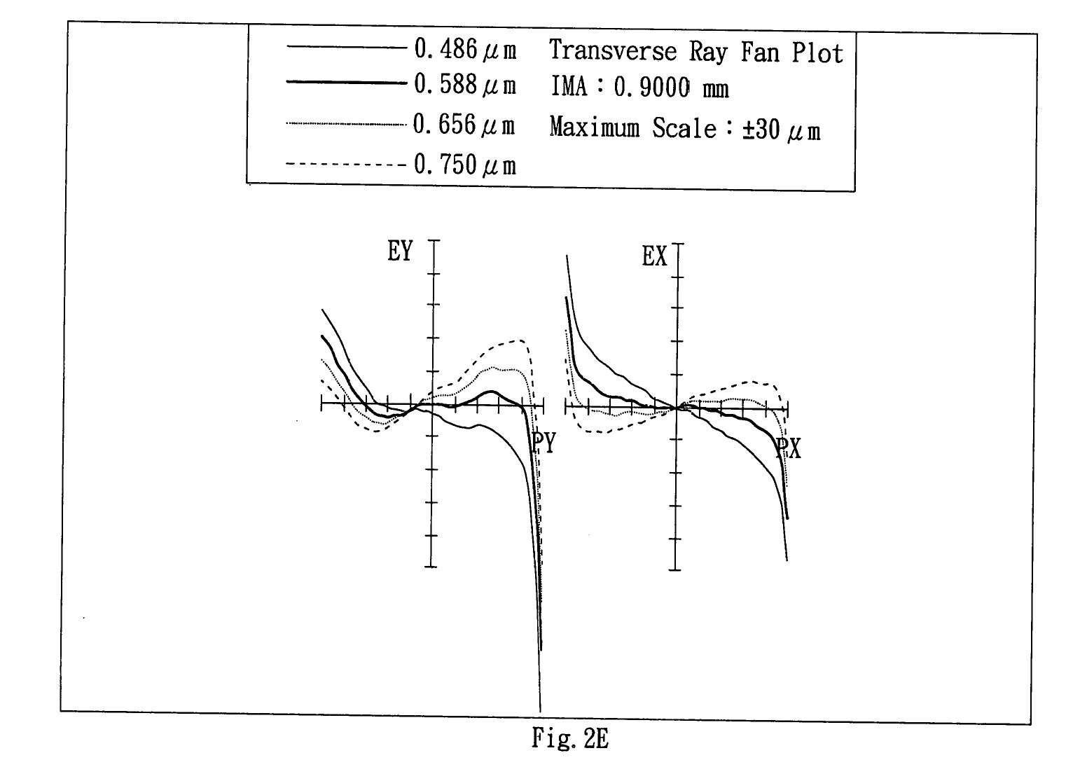

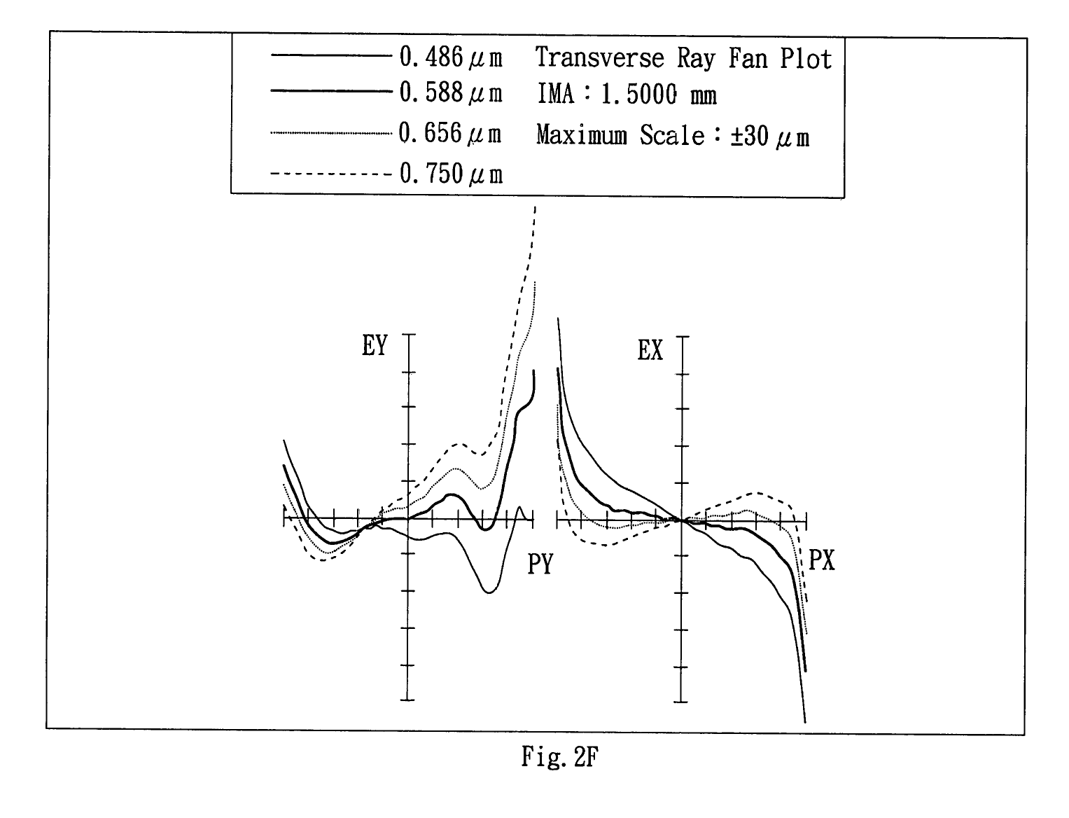

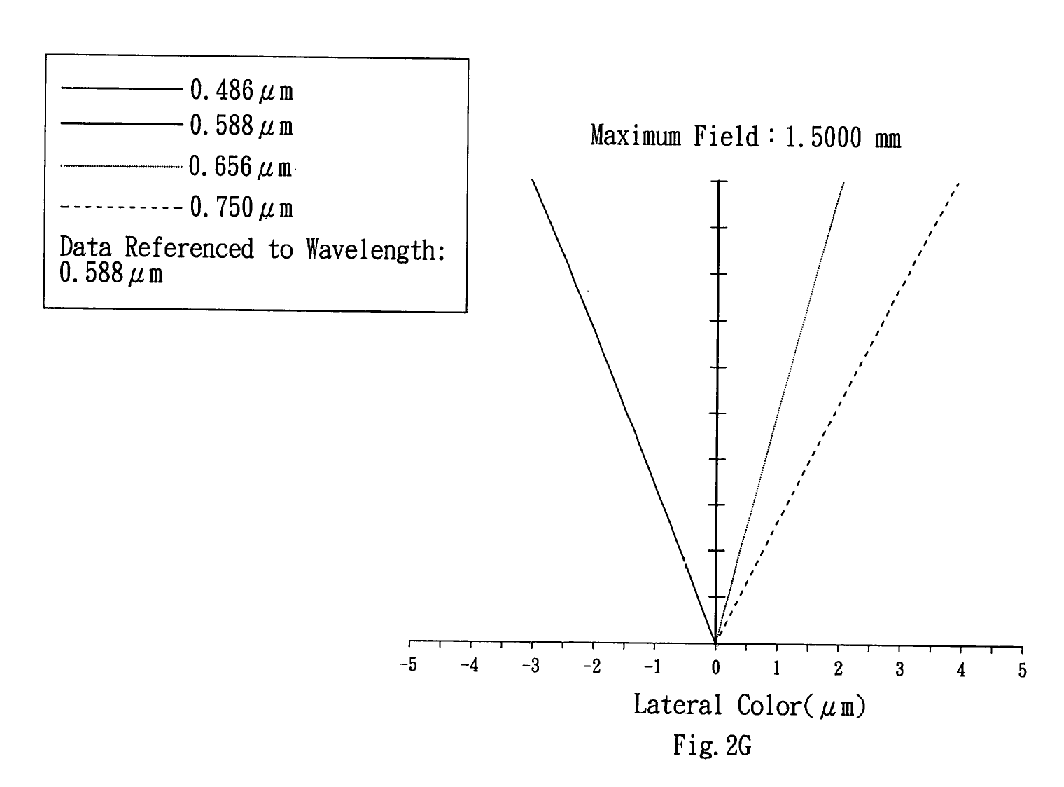

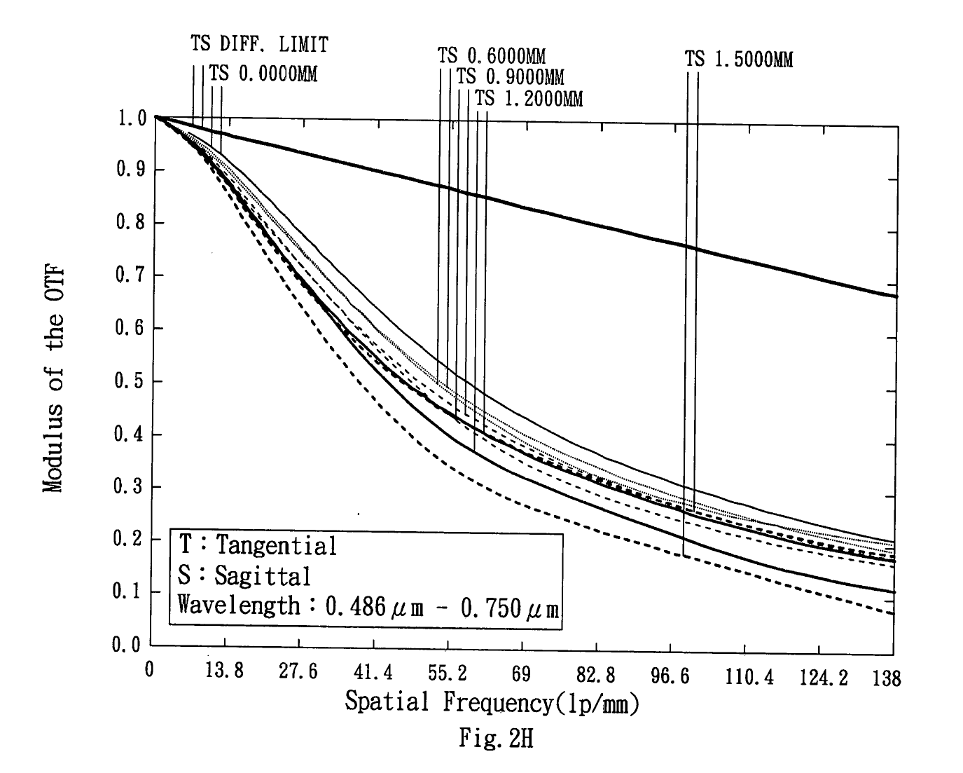

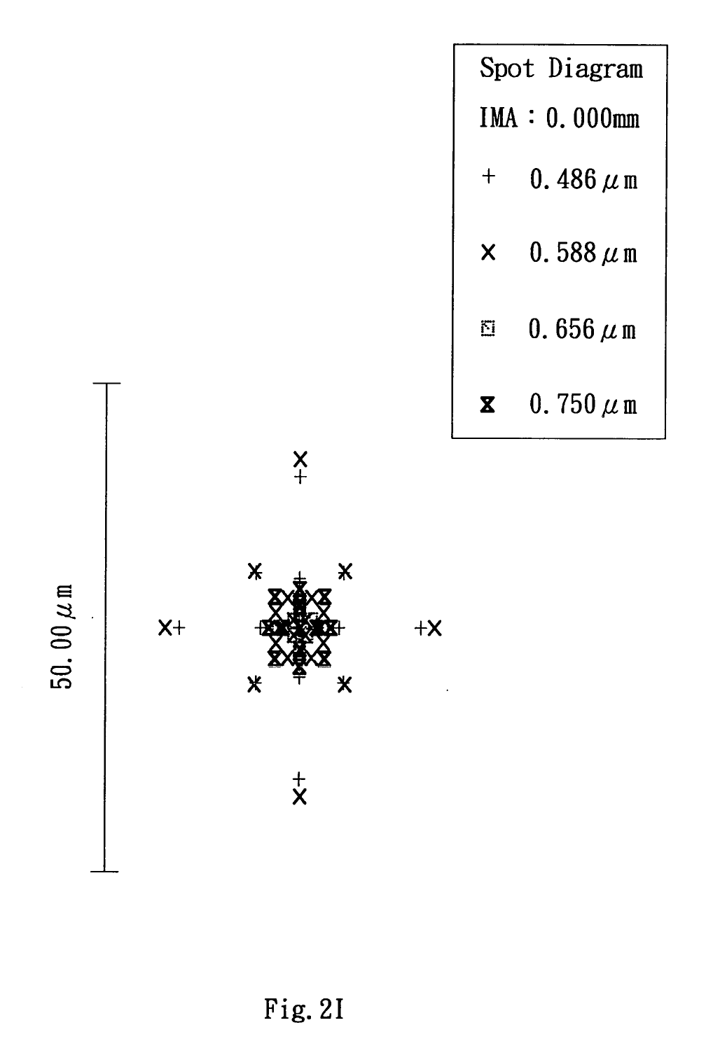

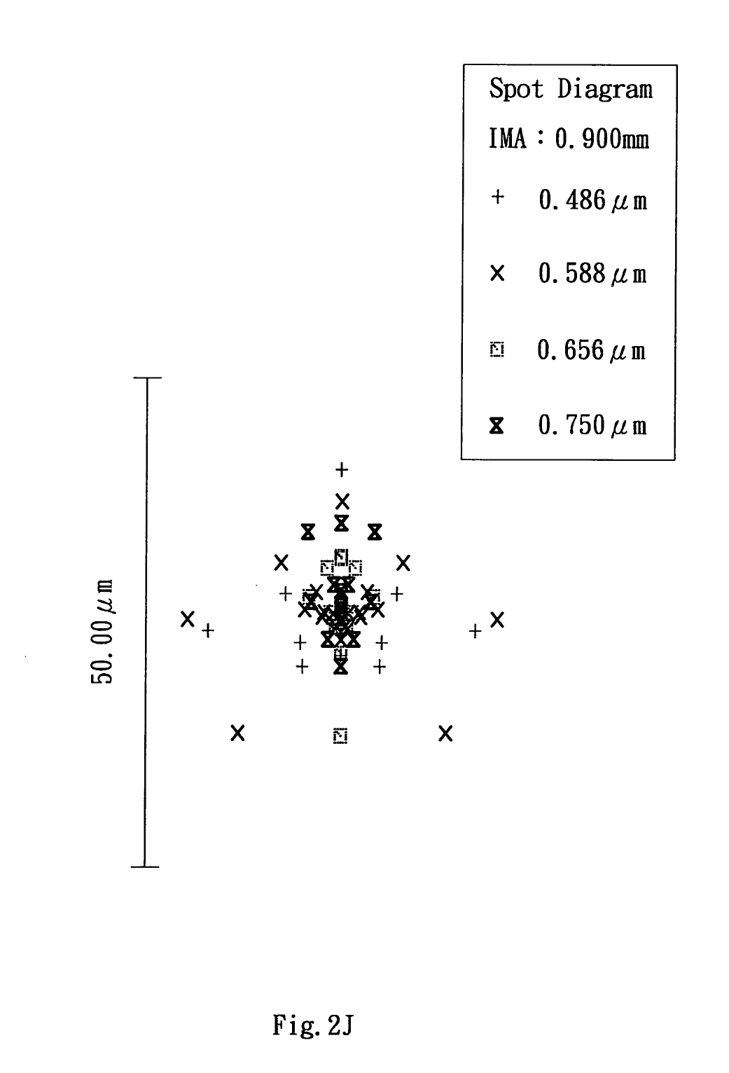

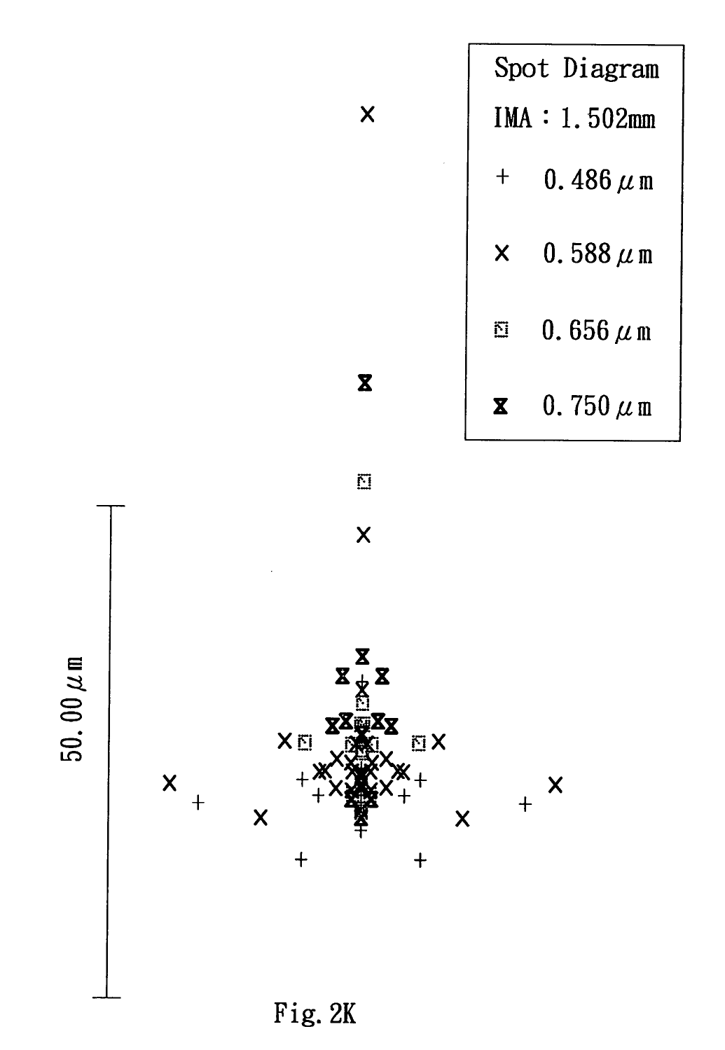

By the above arrangements of the lenses and stop ST1, the lens assembly 1 of the first embodiment can meet the requirements of optical performance as seen in FIGS. 2A-2K, wherein FIG. 2A shows a longitudinal aberration diagram of the lens assembly 1 in accordance with the first embodiment of the invention, FIG. 2B shows a field curvature diagram of the lens assembly 1 in accordance with the first embodiment of the invention, FIG. 2C shows a distortion diagram of the lens assembly 1 in accordance with the first embodiment of the invention, FIGS. 2D-2F show transverse ray fan diagrams of the lens assembly 1 in accordance with the first embodiment of the invention, FIG. 2G shows a lateral color diagram of the lens assembly 1 in accordance with the first embodiment of the invention, FIG. 2H shows a modulation transfer function diagram of the lens assembly 1 in accordance with the first embodiment of the invention and FIGS. 2I-2K show spot diagrams of the lens assembly 1 in accordance with the first embodiment of the invention.

It can be seen from FIG. 2A that the longitudinal aberration in the lens assembly 1 of the first embodiment ranges from −0.15 mm to 0.12 mm for the wavelength of 0.486 μm, 0.588 μm, 0.656 μm and 0.750 μm. It can be seen from FIG. 2B that the field curvature of tangential direction and sagittal direction in the lens assembly 1 of the first embodiment ranges from −0.08 mm to 0.12 mm for the wavelength of 0.486 μm, 0.588 μm, 0.656 μm and 0.750 μm. It can be seen from FIG. 2C(in which the four lines in the figure almost coincide to appear as if a signal line) that the distortion in the lens assembly 1 of the first embodiment ranges from −0.7% to 0% for the wavelength of 0.486 μm, 0.588 μm, 0.656 μm and 0.750 μm. It can be seen from FIGS. 2D-2F that the transverse ray aberration in the lens assembly 1 of the first embodiment ranges from −56.5 μm to 51.2 μm wherein the wavelength is 0.486 μm, 0.588 μm, 0.656 μm and 0.750 μm, each field is 0.0000 mm, 0.9000 mm, and 1.5000 mm, respectively. It can be seen from FIG. 2G that the lateral color with reference wavelength of 0.588 μm in the lens assembly 1 of the first embodiment ranges from −3.5 μm to 4.0 μm for the wavelength of 0.486 μm, 0.588 μm, 0.656 μm and 0.750 μm, with field ranged from 0 mm to 1.5000 mm. It can be seen from FIG. 2H that the modulation transfer function of tangential direction and sagittal direction in the lens assembly 1 of the first embodiment ranges from 0.07 to 1.0 when the wavelength ranges from 0.486 μm to 0.750 μm, the fields respectively are 0.0000 mm, 0.6000 mm, 0.9000 mm, 1.2000 mm and 1.5000 mm, and the spatial frequency ranges from 0 1p/mm to 138 1p/mm. It can be seen from FIGS. 2I-2K that the root mean square spot radius is equal to 6.761 μm, 9.945 μm, 10.264 μm and geometrical spot radius is equal to 17.258 μm, 44.416 μm, 37.688 μm for the field of 0.000 mm, 0.900 mm and 1.502 mm, and wavelength of 0.486 μm, 0.588 μm, 0.656 μm and 0.750 μm in the lens assembly 1 of the first embodiment. It is obvious that the longitudinal aberration, the field curvature, the distortion, the transverse ray aberration and the lateral color of the lens assembly 1 of the first embodiment can be corrected effectively, and the resolution of the lens assembly 1 of the first embodiment can meet the requirement. Therefore, the lens assembly 1 of the first embodiment is capable of good optical performance.

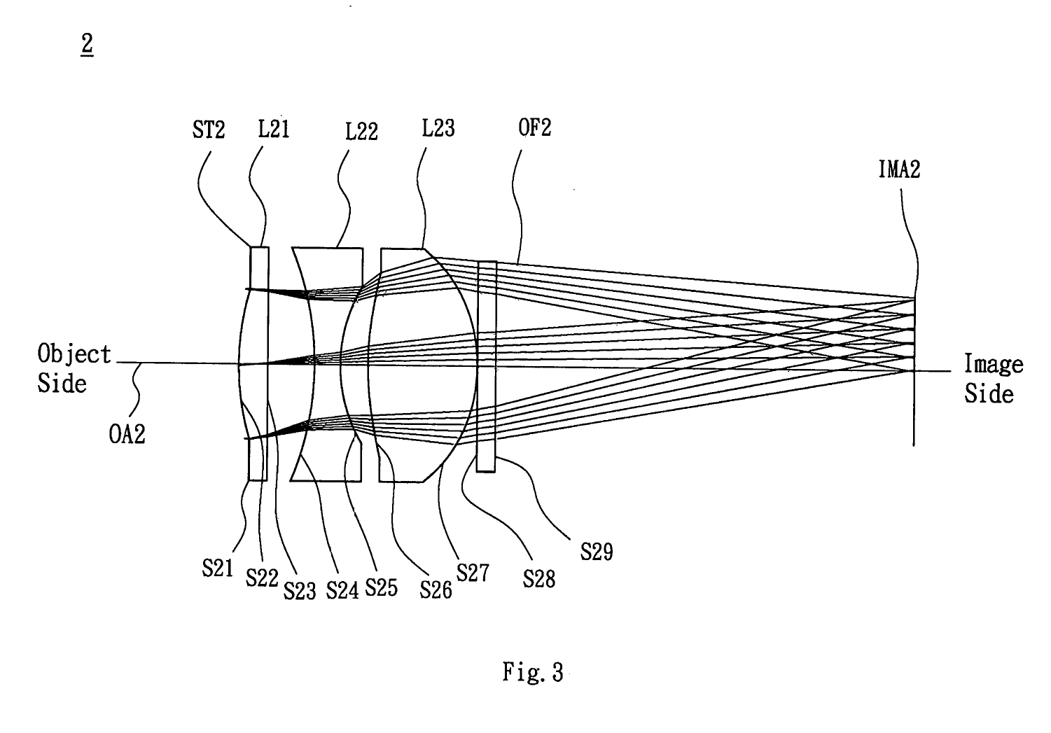

Referring to FIG. 3, FIG. 3 is a lens layout and optical path diagram of a lens assembly in accordance with a second embodiment of the invention. The lens assembly 2 includes a stop ST2, a first lens L21, a second lens L22, a third lens L23 and an optical filter OF2, all of which are arranged in sequence from an object side to an image side along an optical axis OA2. In operation, an image of light rays from the object side is formed at an image plane IMA2. The first lens L21 is a plano-convex lens with positive refractive power and made of plastic material, wherein the object side surface S22 is a convex surface, the image side surface S23 is a plane surface and the object side surface S22 is a spherical surface. The second lens L22 is a biconcave lens with negative refractive power and made of plastic material, wherein both of the object side surface S24 and image side surface S25 are spherical surfaces. The third lens L23 is a biconvex lens with positive refractive power and made of plastic material, wherein both of the object side surface S26 and image side surface S27 are aspheric surfaces. Both of the object side surface S28 and image side surface S29 of the optical filter OF2 are plane surfaces.

In order to maintain excellent optical performance of the lens assembly in accordance with the second embodiment of the invention, the lens assembly 2 must satisfy the following four conditions:

0<f2₁/f2<1 (5)

f2₂/f2<0 (6)

0<f2₃/f2<1 (7)

0<BFL2/TTL2<1 (8)

wherein f2 is an effective focal length of the lens assembly 2, f2₁ is an effective focal length of the first lens L21, f2₂ is an effective focal length of the second lens L22, f2₃ is an effective focal length of the third lens L23, BFL2 is an interval from the image side surface S27 of the third lens L23 to the image plane IMA2 along the optical axis OA2, and TTL2 is an interval from the object side surface S22 of the first lens L21 to the image plane IMA2 along the optical axis OA2. When the condition (5) is satisfied, the positive refractive power of the first lens L21 can be adjusted appropriately so as to help shortening the total lens length of the lens assembly 2. When the condition (6) is satisfied, the negative refractive power of the second lens L22 can be adjusted appropriately so as to compensate aberration that is generated by the positive first lens L21. When the condition (7) is satisfied, the positive refractive power of the third lens L23 can be adjusted appropriately so that the lens assembly 2 has a shorter total lens length, the refraction change of light is gentler after pass through the lens, and can effectively reduce the generation of aberration and the loss of peripheral brightness. When the condition (8) is satisfied, it ensures that the optical system has enough back focal length to assemble and focus the lens assembly 1.

By the above design of the lenses and stop ST2, the lens assembly 2 is provided with a shortened total lens length, an effective corrected aberration and an increased resolution.

In order to achieve the above purposes and effectively enhance the optical performance, the lens assembly 2 in accordance with the second embodiment of the invention is provided with the optical specifications shown in Table 3, which include the effective focal length, F-number, total lens length, radius of curvature of each lens surface in mm, thickness between adjacent surface in mm, refractive index of each lens and Abbe number of each lens, and surface number S21-S29 represent surfaces in sequence from the object side to the image side. Table 3 shows that the effective focal length is equal to 9.4848 mm, F-number is equal to 3.0 and total lens length is equal to 14.7115 mm for the lens assembly 2 of the second embodiment of the invention.

TABLE 3
Effective Focal Length = 9.4848 mm F-number = 3.0
Total Lens Length = 14.7115 mm

| | Radius of | | | | |
|---|---|---|---|---|---|
| Surface | Curvature | Thickness | | | |
| Number | (mm) | (mm) | Nd | Vd | Remark |
| S21 | ∞ | −0.236 | | | Stop ST2 |
| S22 | 5.413 | 0.627 | 1.585 | 29.90 | The First Lens L21 |
| S23 | ∞ | 1.021 | | | |
| S24 | −6.187 | 0.563 | 1.585 | 29.90 | The Second Lens L22 |
| S25 | 3.151 | 0.604 | | | |
| S26 | 6.222 | 2.384 | 1.525 | 56.35 | The Third Lens L23 |
| S27 | −3.348 | 0 | | | |
| S28 | ∞ | 0.4 | 1.516 | 64.1 | Optical Filter OF2 |
| S29 | ∞ | 9.113 | | | |

The aspheric surface sag z of each lens in table 3 can be calculated by the following formula:

z=ch²/{1+[1−(k+1)c²h²]^{1/2}}+Ah⁴+Bh⁶+Ch⁸+Dh¹⁰+Eh¹²+Fh¹⁴

where c is curvature, h is the vertical distance from the lens surface to the optical axis, k is conic constant and A, B, C, D, E and F are aspheric coefficients.

In the second embodiment, the conic constant k and the aspheric coefficients A, B, C, D, E, F of each surface are shown in Table 4.

TABLE 4

| Surface | | | | | | | |
|---|---|---|---|---|---|---|---|
| Number | k | A | B | C | D | E | F |
| S26 | −2.744 | −4.16E−04 | −1.81E−03 | 1.98E−03 | −1.18E−03 | 2.93E−04 | −2.47E−05 |
| S27 | −0.182 | −1.73E−03 | 7.73E−04 | −4.26E−04 | 7.13E−05 | −9.70E−06 | 7.99E−07 |

For the lens assembly 2 of the second embodiment, the effective focal length f2 of the lens assembly 2 is equal to 9.4848 mm, the effective focal length f2₁ of the first lens L21 is equal to 9.2449 mm, the effective focal length f2₂ of the second lens L22 is equal to −3.4884 mm, the effective focal length f2₃ of the third lens L23 is equal to 4.5322 mm, the interval BFL2 from the image side surface S27 of the third lens L23 to the image plane IMA2 along the optical axis OA2 is equal to 9.5130 mm and the interval TTL2 from the object side surface S22 of the first lens L21 to the image plane IMA2 along the optical axis OA2 is equal to 14.7115 mm. According to the above data, the following values can be obtained:

f2₁/f2=0.975,

f2₂/f2=−0.368,

f2₃/f2=0.478,

BFL2/TTL2=0.647

which respectively satisfy the above conditions (5)-(8).

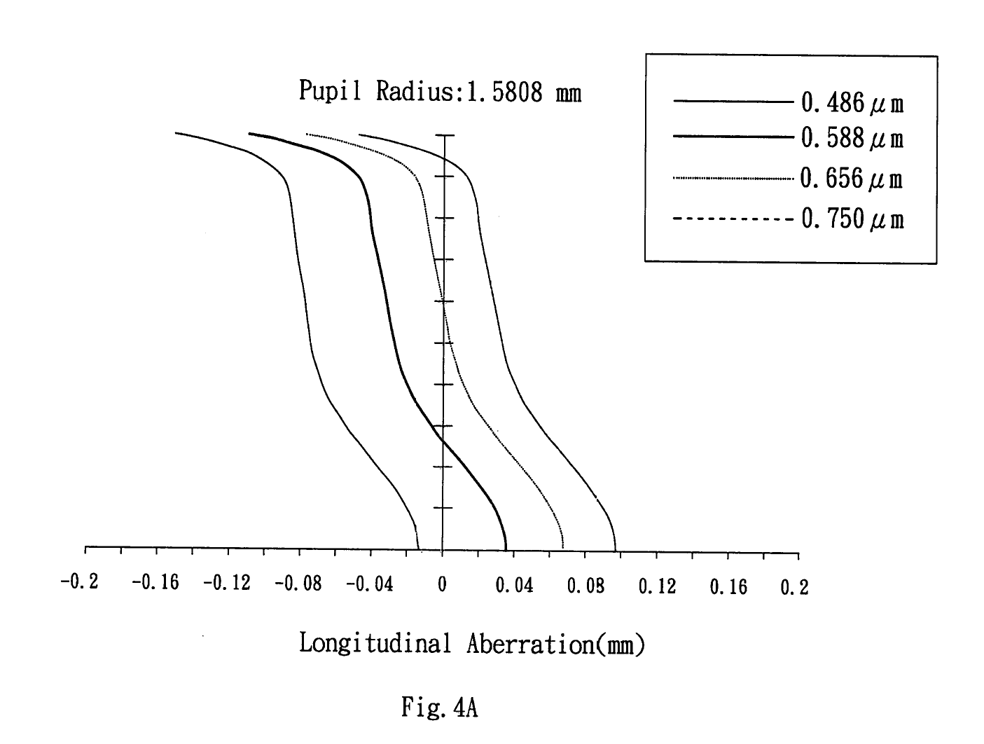

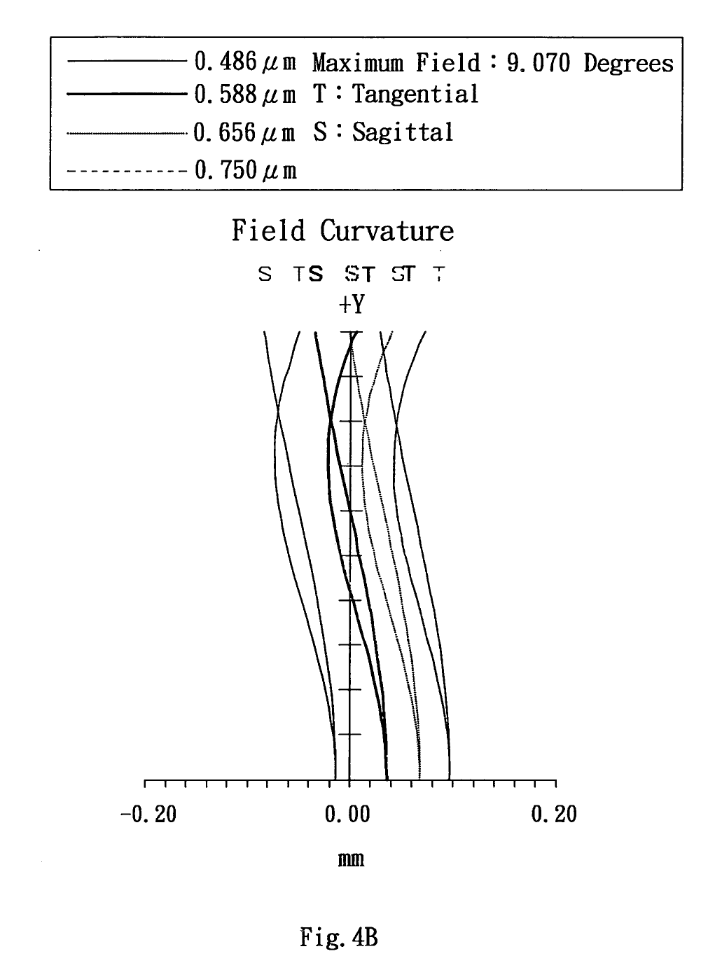

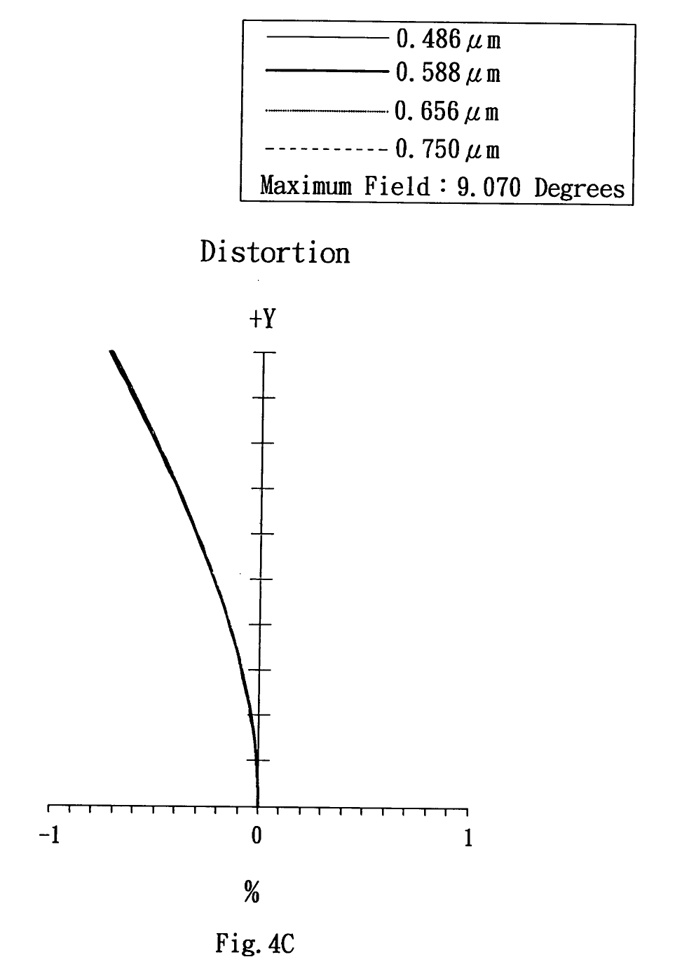

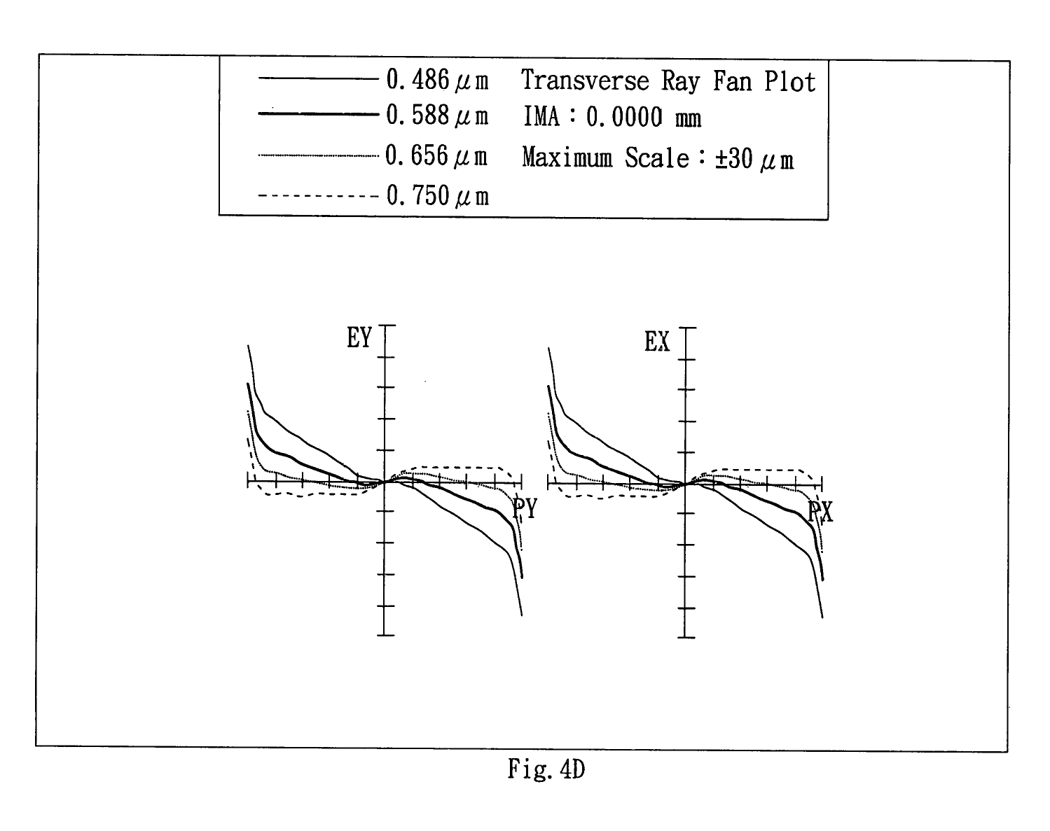

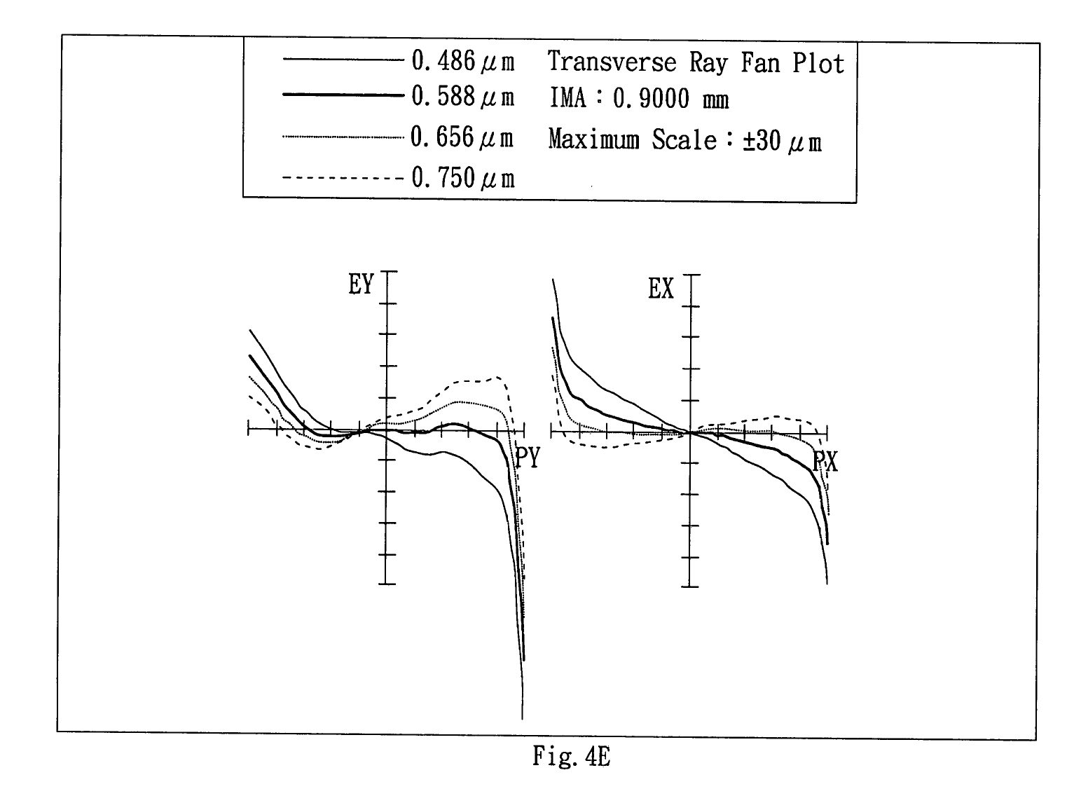

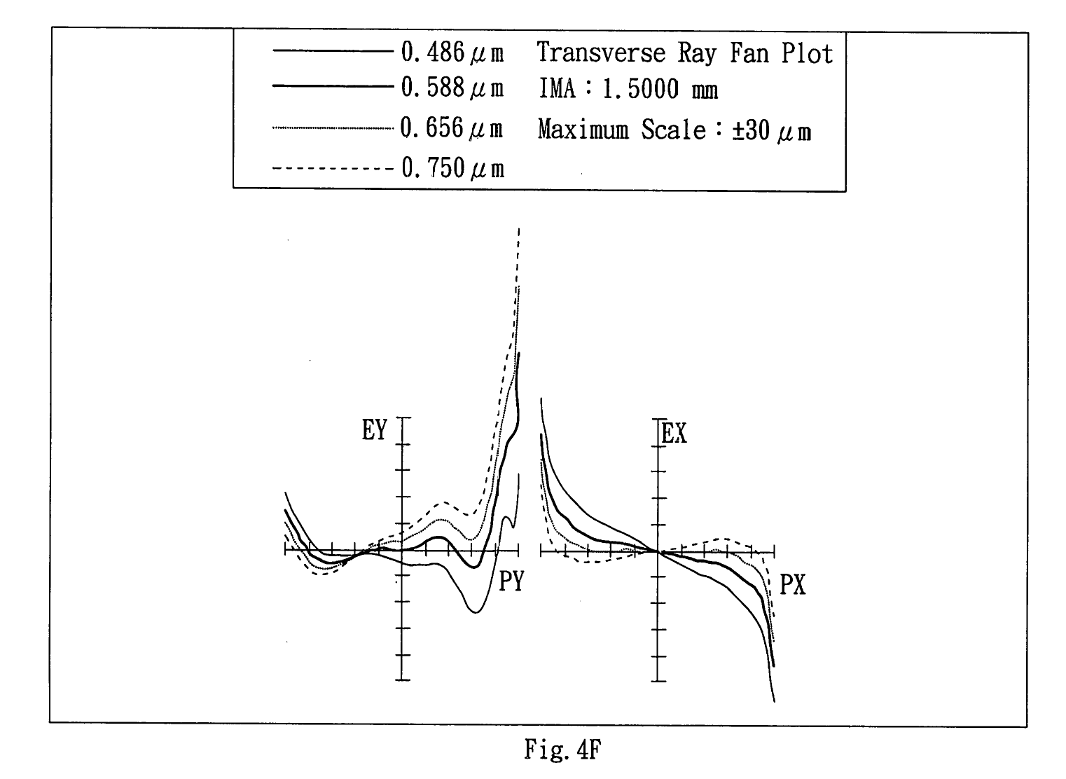

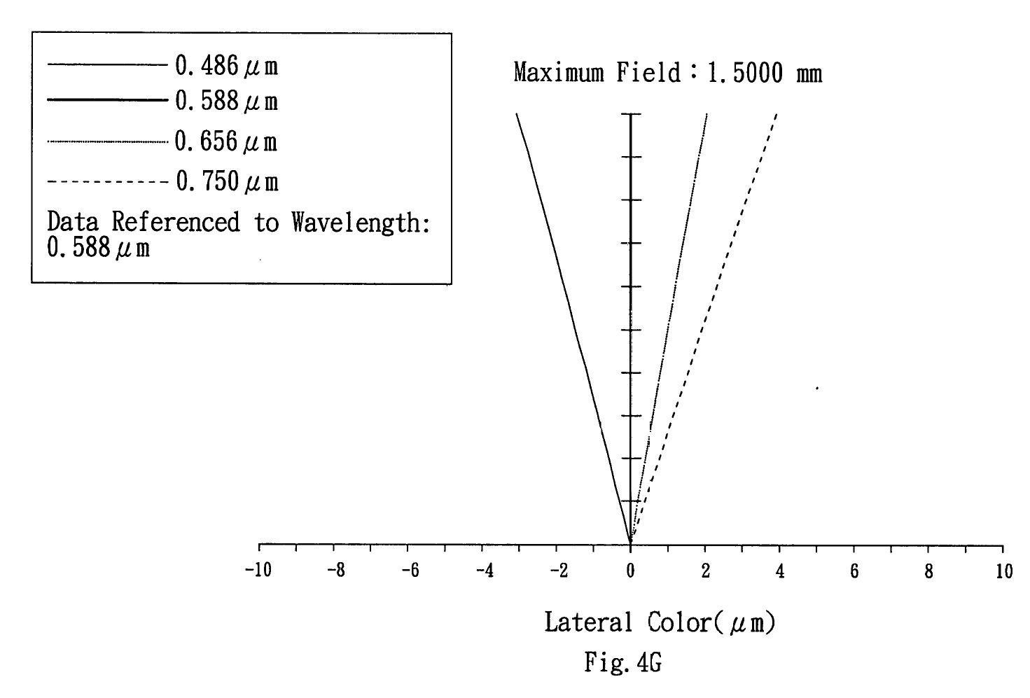

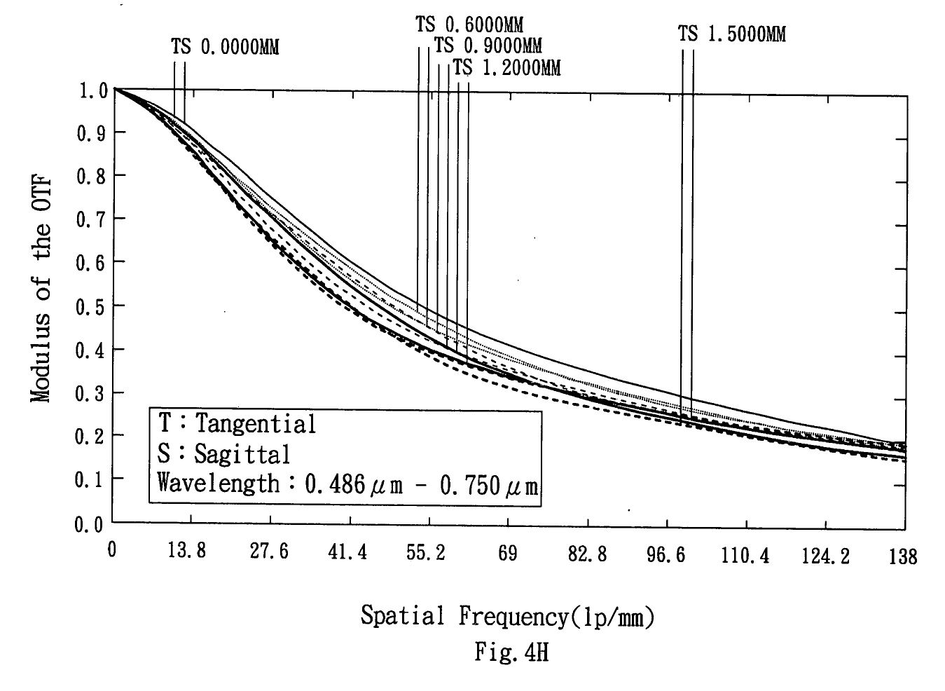

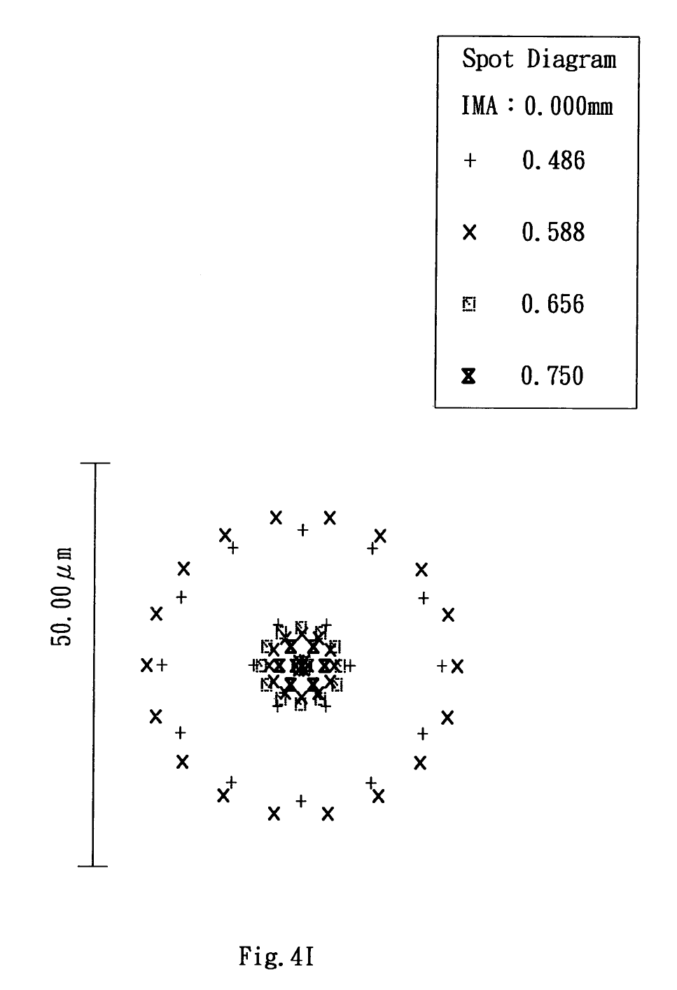

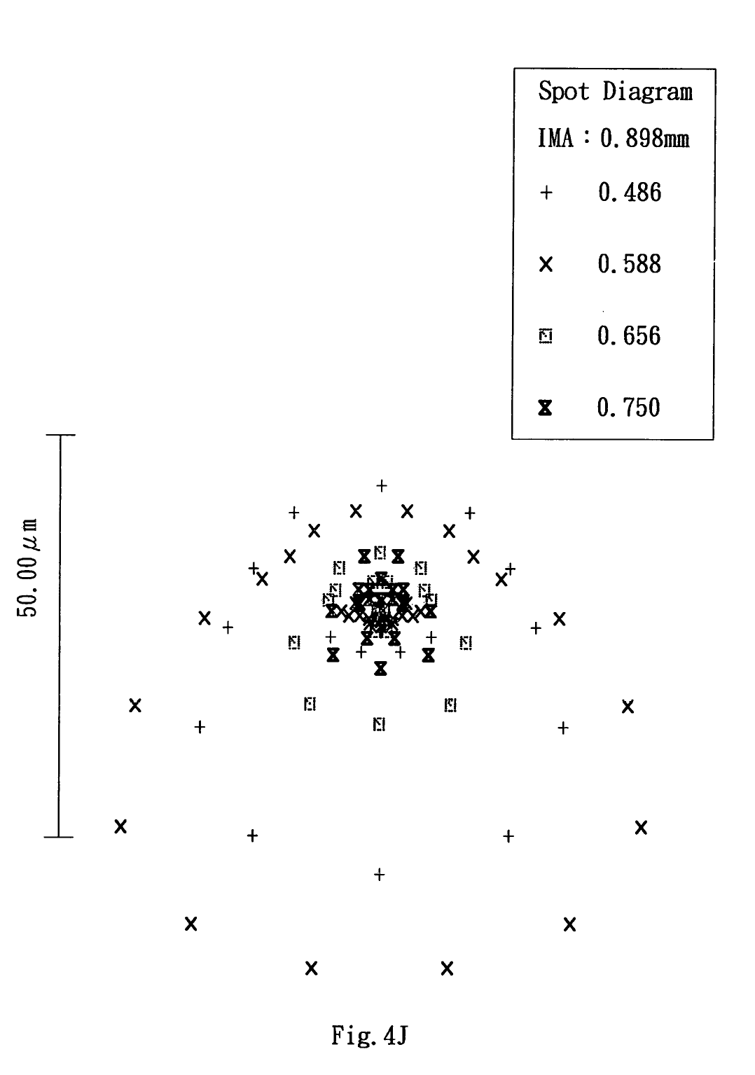

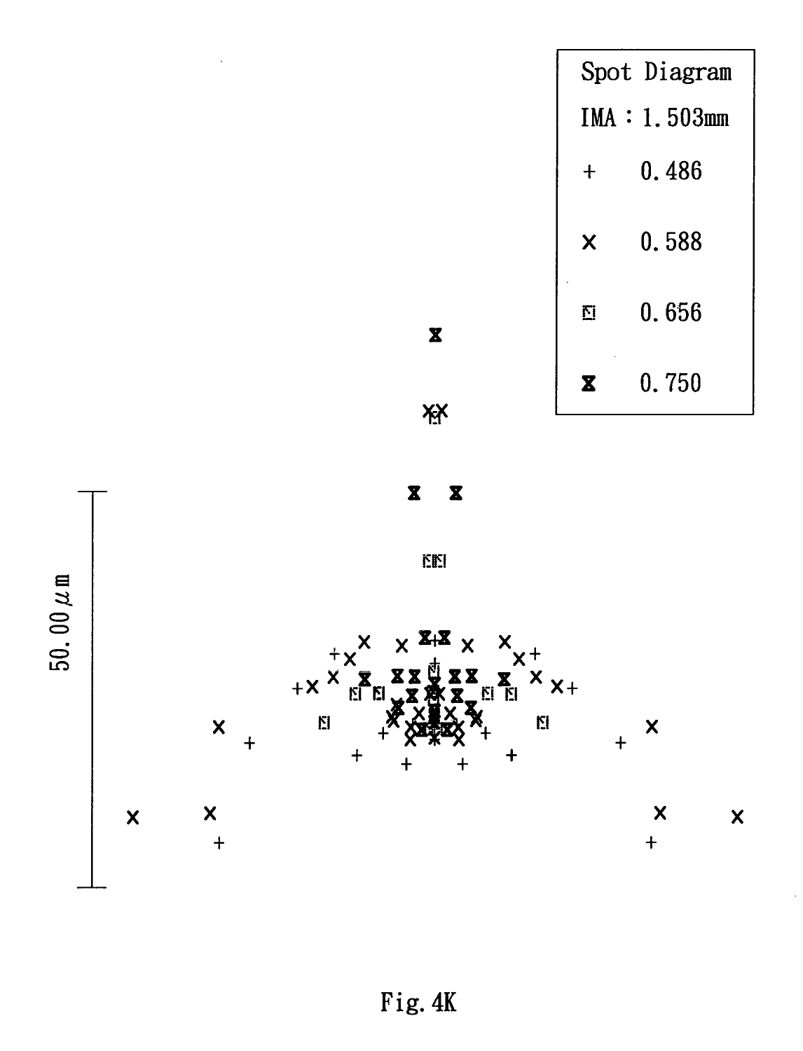

By the above arrangements of the lenses and stop ST2, the lens assembly 2 of the second embodiment can meet the requirements of optical performance as seen in FIGS. 4A-4K, wherein FIG. 4A shows a longitudinal aberration diagram of the lens assembly 2 in accordance with the second embodiment of the invention, FIG. 4B shows a field curvature diagram of the lens assembly 2 in accordance with the second embodiment of the invention, FIG. 4C shows a distortion diagram of the lens assembly 2 in accordance with the second embodiment of the invention, FIGS. 4D-4F show transverse ray fan diagrams of the lens assembly 2 in accordance with the second embodiment of the invention, FIG. 4G shows a lateral color diagram of the lens assembly 2 in accordance with the second embodiment of the invention, FIG. 4H shows a modulation transfer function diagram of the lens assembly 2 in accordance with the second embodiment of the invention and FIGS. 4I-4K show spot diagrams of the lens assembly 2 in accordance with the second embodiment of the invention.

It can be seen from FIG. 4A that the longitudinal aberration in the lens assembly 2 of the second embodiment ranges from −0.16 mm to 0.10 mm for the wavelength of 0.486 μm, 0.588 μm, 0.656 μm and 0.750 μm. It can be seen from FIG. 4B that the field curvature of tangential direction and sagittal direction in the lens assembly 2 of the second embodiment ranges from −0.10 mm to 0.10 mm for the wavelength of 0.486 μm, 0.588 μm, 0.656 μm and 0.750 μm. It can be seen from FIG. 4C(in which the four lines in the figure almost coincide to appear as if a signal line) that the distortion in the lens assembly 2 of the second embodiment ranges from −0.8% to 0% for the wavelength of 0.486 μm, 0.588 μm, 0.656 μm and 0.750 μm. It can be seen from FIGS. 4D-4F that the transverse ray aberration in the lens assembly 2 of the second embodiment ranges from −54.4 μm to 71.3 μm wherein the wavelength is 0.486 μm, 0.588 μm, 0.656 μm and 0.750 μm, each field is 0.0000 mm, 0.9000 mm, and 1.5000 mm, respectively. It can be seen from FIG. 4G that the lateral color with reference wavelength of 0.588 μm in the lens assembly 2 of the second embodiment ranges from −3.1 μm to 4.0 μm for the wavelength of 0.486 μm, 0.588 μm, 0.656 μm and 0.750 μm, with field ranged from 0 mm to 1.5000 mm. It can be seen from FIG. 4H that the modulation transfer function of tangential direction and sagittal direction in the lens assembly 2 of the second embodiment ranges from 0.15 to 1.0 when the wavelength ranges from 0.486 μm to 0.750 μm, the fields respectively are 0.0000 mm, 0.6000 mm, 0.9000 mm, 1.2000 mm and 1.5000 mm, and the spatial frequency ranges from 0 1p/mm to 138 1p/min. It can be seen from FIGS. 4I-4K that the root mean square spot radius is equal to 10.488 μm, 15.797 μm, 15.348 μm and geometrical spot radius is equal to 18.625 μm, 42.478 μm, 44.617 μm for the field of 0.000 mm, 0.898 mm and 1.503 mm, and wavelength of 0.486 μm, 0.588 μm, 0.656 μm and 0.750 μm in the lens assembly 2 of the second embodiment. It is obvious that the longitudinal aberration, the field curvature, the distortion, the transverse ray aberration and the lateral color of the lens assembly 2 of the second embodiment can be corrected effectively, and the resolution of the lens assembly 2 of the second embodiment can meet the requirement. Therefore, the lens assembly 2 of the second embodiment is capable of good optical performance.

What is claimed is:

1. A lens assembly comprising a stop, a first lens, a second lens and a third lens, all of which are arranged in sequence from an object side to an image side along an optical axis, wherein:
the first lens is a plano-convex lens with positive refractive power and comprises a convex surface facing the object side;
the second lens is with negative refractive power;
the third lens is with positive refractive power and comprises a convex surface facing the object side; and
the third lens satisfies:
0<f₃/f<1
wherein f₃ is an effective focal length of the third lens and f is an effective focal length of the lens assembly.

2. The lens assembly as claimed in claim 1, wherein the first lens satisfies:
0<f₁/f<1
wherein f₁ is an effective focal length of the first lens and f is an effective focal length of the lens assembly.

3. The lens assembly as claimed in claim 1, wherein the second lens satisfies:
f₂/f<0
wherein f₂ is an effective focal length of the second lens and f is an effective focal length of the lens assembly.

4. The lens assembly as claimed in claim 1, wherein the lens assembly satisfies:
0<BFL/TTL<1
wherein BFL is an interval from an image side surface of the third lens to an image plane along the optical axis and TTL is an interval from the convex surface of the first lens to the image plane along the optical axis.

5. The lens assembly as claimed in claim 1, wherein the first lens and the second lens are spherical lenses.

6. The lens assembly as claimed in claim 1, wherein the third lens is an aspheric lens.

7. The lens assembly as claimed in claim 1, wherein the first lens, the second lens and the third lens are made of plastic material.

8. The lens assembly as claimed in claim 1, further comprising an optical filter disposed between the third lens and the image side.

9. The lens assembly as claimed in claim 1, wherein the second lens is a biconcave lens and the third lens is a biconvex lens.

10. A lens assembly comprising a stop, a first lens, a second lens and a third lens, all of which are arranged in sequence from an object side to an image side along an optical axis, wherein:
the first lens with positive refractive power;
the second lens with negative refractive power; and
the third lens with positive refractive power, satisfies:
0<f₁/f<1,
f₂/f<0,
0<f₃/f<1, and
0<BFL/TTL<1,
where f₁ is an effective focal length of the first lens, f is an effective focal length of the lens assembly, f₂ is an effective focal length of the second lens, f₃ is an effective focal length of the third lens, BFL is an interval from an image side surface of the third lens to an image plane along the optical axis, and TTL is an interval from the convex surface of the first lens to the image plane along the optical axis.

11. The lens assembly as claimed in claim 10, wherein the first lens is a convex surface facing the object side.

12. The lens assembly as claimed in claim 11, wherein the first lens is a plano surface facing the image side.

13. The lens assembly as claimed in claim 10, wherein the second lens is a concave surface facing the object side.

14. The lens assembly as claimed in claim 13, wherein the second lens is a concave surface facing the image side.

15. The lens assembly as claimed in claim 10, wherein the third lens is a convex surface facing the object side.

16. The lens assembly as claimed in claim 15, wherein the third lens is a convex surface facing the image side.
